(19) United States
(12) Patent Application Publication
(10) Pub. No.: US 2018/0238091 A1
(43) Pub. Date: Aug. 23, 2018

(54) HINGE OF THE 3D ADJUSTABLE HIDDEN TYPE

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/753,955

(22) PCT Filed: Oct. 3, 2016
(86) PCT No.: PCT/MX2016/000099

§ 371 Date: Feb. 20, 2018

(30) Foreign Application Priority Data
Aug. 10, 2016 (MX) MX/U/2016/000337

(51) Int. Cl. E05D 7/04; E05D 11/08; E05D 3/06

(52) U.S. Cl. CPC E05D 7/0423; E05D 11/08; E05D 3/06; E05F 1/1284; E05D 2007/0492; E05Y 2800/674; E05Y 2900/132

(57) ABSTRACT

A HINGE COMPRISING A PRIMARY SYMMETRICBODY FIXED TO A FRAME, WITH A CENTRAL COUPLING OPENING; A SECOND SYMMETRIC BODY FIXED TO A DOOR, WITH A COUPLING OPENING, UNITED IN BETWEEN THROUGH AN OPENING AND CLOSING MECHANISM, WHEREIN A TOP ARM, A LOWER ARM, UNITED IN BETWEEN THROUGH A CENTRAL REGULATION SCREW, THE TOP ARM IS ARTICULATED BY A PART TO THE SECOND SYMMETRIC BODY AND DISPLACABLE THROUGH A CHANNEL LOCATED IN THE FIRST SYMMETRIC BODY AND THE LOWER ARM IN AN INVERSE WAY, WITH THE PARTICULARITY THAT BOTH ARMS ARE SHAPED BY ARCHED PIECES, BEING BOTH ARMS ARTICULATED IN BETWEEN THEMSELVES IN CORRESPONDENCE WITH A CROSSING-ZONE AMONG THEMSELVES; A REGULATION OF TM INCLINATION OF THE DOOR'S TOP PART'S SCREW; A REGULATION OF INCLINATION OF THE DOOR'S LOWER PART'S SCREW; A DOOR'S HEIGHT TOP PART REGULATION SCREW, A DOOR'S HEIGHT LOWER PART REGULATION SCREW, A LATERAL REGULATION SCREW, TOP PRISONER SCREW, LOWER PRISONER SCREW AND A DISPLACEMENT CHANNEL.

### PREVIEWS OF THE INVENTION

A HINGE OF THE 3D ADJUSTABLE HIDDEN TYPE, NOWDAYS, IT IS KNOWN A GREAT VARIETY OF HINGES, FOR EXAMPLE, THE ADJUSTABLE HINGES, OR THOSE THAT ARE INSTALLED IN THE FRAME AS IN THE DOOR LIKE THOSE ON DOORS THAT ARE HIDDEN, THE ARTICULATED ONES, OR THE CONVENTIONAL ONES WITH BASIC FUNCTIONS; THOSE HINGES DO NOT COUNT WITH AN ADJUSTABLE LATERAL SYSTEM, THE VERTICAL ONES, THE HORIZONTAL ONES, AND THE HEIGHT ONES WITH SPECIFIC TOOLS LIKE ALLEN TOOLS. THE PREVIOUS EXAMPLES HAVE AS LIMITATION, THAT THEY ARE NOT BUILT WITH RESISTANT MATERIALS, THAT THEY ARE VERY NOISY, AND THAT WITH THE DAILY USE, THE DOORS LOSE THE FUNCTION, OR THEY GET DETERIORATED WITH THE SUN'S EXPOSITION, THE RAIN AND SALINITY'S EFFECTS.

THE CURRENT INVENTION SEEKS TO SOLVE THIS TECHNICAL PROBLEM, BY ADDING ANADJUSTABLE LATERAL SYSTEM, A HEIGHT ONE, A DEPTH ONE, AND SOFT-CLOSURE, AS WELL AS A RESISTANT MATERIAL TO CORROTION, TO THE SUN, TO THE RAIN AND THE KNOWN SALINITY LEVELS; A ZINC ALLOY WITH ALUMINUM, MAGNISIUM, AND COPPER.

### DESCRIPTION OF THE INVENTION

THE NOVELTY OF THIS INVENTION IS CLEARLY SHOWN IN THE DRAWINGS THAT ARE ATTACHED TO THE PRESENT APPLICATION, AND ACCORDING TO THE DESCRIPTION SHOWN BELOW WE DECIDED THAT THE ALPHA-NUMERIC REFERENCES BELONG TO EACH OF THE STRUCTURAL ELEMENTS THAT SHAPE THIS INVENTION.

### BRIEF DESCRIPTION OF THE FIGURES

FIG. 1, IS A VIEW OF THE HINGE IN DISPLAY AND THE STRUCTURAL PARTS THAT IT IS MADE OF.

FIG. 2, IS A VIEW OF THE HINGE IN A CLOSED POSITION.

FIG. 3, IS A VIEW OF THE HINGE IN AN OPENED POSITION.

FIG. 4, IS A VIEW OF THE ADJUSTMENT LATERAL SCREW; ADJUSTING THE DOOR LATERALLY.

FIG. 5, IS A VIEW OF THE DEPTH ADJUSTMENT SCREW; ADJUSTING THE DOOR'S DEPTH.

FIG. 6, IS A VIEW OF THE HEIGHT ADJUSTMENT SCREW; ADJUSTING THE DOOR'S HEIGHT IN THE HINGE.

FIG. 7, IS A VIEW OF THE CENTRAL REGULATION SCREW OF THE HINGE'S OPENING AND CLOSING MECHANISM

### IN DETAILED DESCRIPTION OF THE INVENTION

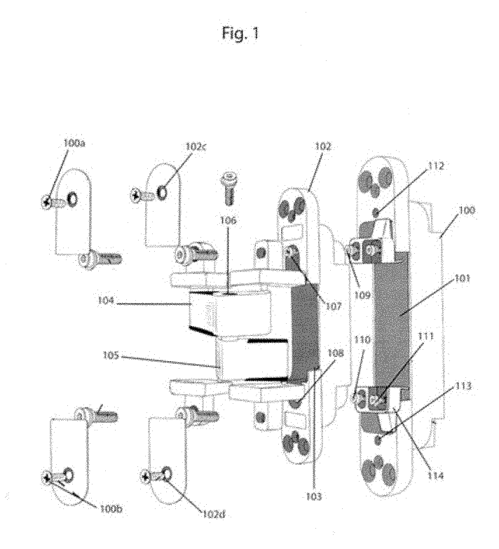

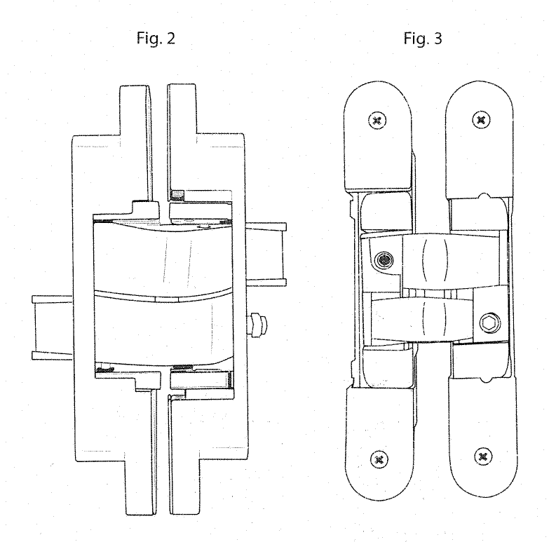

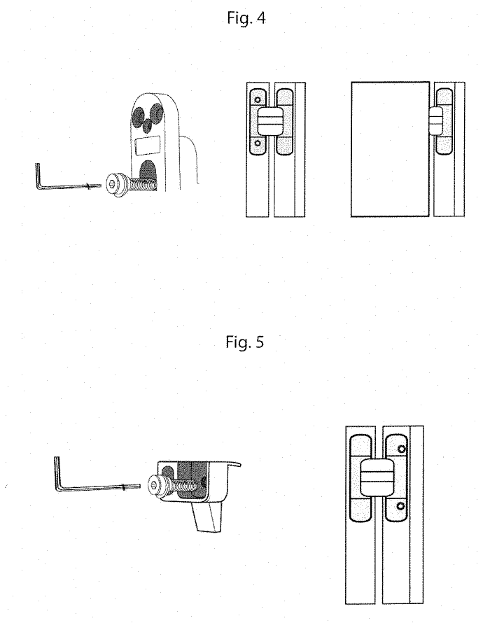

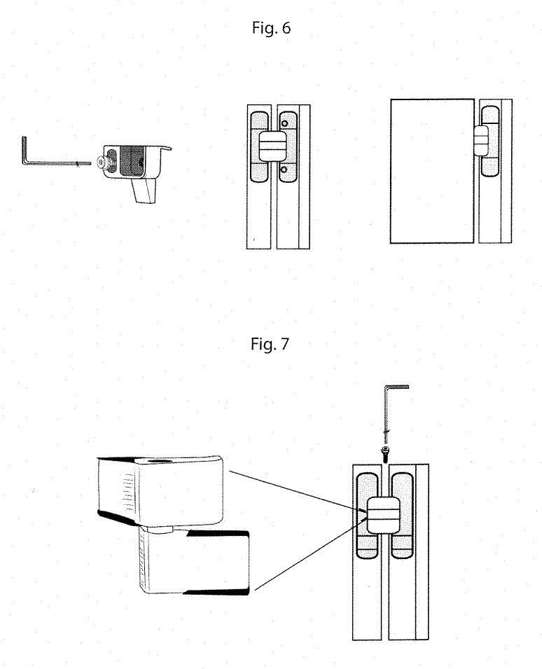

IN REFERENCE TO FIG. 1, THE HINGE OF THE 3D ADJUSTABLE HIDDEN TYPE THAT COMPRENHENDS A SYMMETRICAL FIRST BODY (100), IN BOTH EXTREMES WITH SEMICIRCLE TERMINATION THAT COMPRENHENDS A TOP COVER (100a), A LOWER COVER (100b) FIXED TO THE FRAME, WITH A CENTRAL COUPLING OPENING (101); A SECOND SYMMETRICAL BODY (102) IN BOTH EXTREMES WITH SEMICIECLE TERMINATION THAT COMPRENHENDS A TOP COVER (102c), AN LOWER COVER (102d); ATTACHED TO THE DOOR, WITH A COUPLING OPENING (103), UNITED IN BETWEEN THEM THROUGH AN OPENING AND CLOSING MECHANISM, CHARACTERIZED BY A TOP ARM (104), A LOWER ARM (105), UNITED IN BETWEEN THEM BY A CENTRAL REGULATION SCREW (106), THE TOP ARM IS ARTICULATED BY A PART TO THE SECOND SYMMETRIC BODY AND DISPLACABLE THROUGH A CHANNEL LOCATED IN THE FIRST SYMMETRIC BODY AND THE LOWER ARM IN AN INVERSE FORM, WITH THE PARTICULARITY THAT BOTH ARMS ARE MADE OF BY ARCHED PIECES, BEING BOTH ARMS ARTICULATED IN BETWEEN THEM IN CORRESPONDENCE WITH A CROSSING ZONE AMONG THEMSELVES; A REGULATION OF THE INCLINATION OF THE DOOR'S TOP'S SCREW (107); A REGULATION OF THE INCLINATION OF THE DOOR'S BOTTOM'S SCREW (108); A HEIGHT'S REGULATION OF THE DOOR'S TOP PART SCREW (109), OF HEIGHT REGULATION OF THE DOOR'S LOWER PART'S SCREW (110), OFSCREW OF LATERAL REGULATION (111), TOP PRISONER SCREW (112), LOWER PRISONER SCREW (113), DISPLACEMENT CHANNEL (114).

THE HINGE OF THE 3D ADJUSTABLE HIDDEN TYPE, IS DESIGNED TO SUPPORT DOORS WITH WEIGHTS FROM 80 KILOGRAMS TO 120 KILOGRAMS; SUCH AN ADJUSTABLE HIDDEN HINGE IS MANUFACTURED WITH A ZINC ALLOY WITH ALUMINUM, MAGNESIUM, AND COPPER, MATERIALS HIGHLY RESISTANT TO CORROSION, TO THE SUN, THE RAIN, AND SALINITY. THE ADJUSTABLE SYSTEM HELPS WHERE THE DOOR CAN BE LATERALLY ADJUSTED TO +2.5 MM. HEIGHT +2.5 MM. DEPTH +1.0 MM.

THE ADJUSTABLE 3D HIDDEN HINGE, COMPRENHENDS A CENTRAL REGULATION SCREW OF THE OPENING AND CLOSING MECHANISM, THAT WITH THE AID OF AN ALLEN TOOL, THE PRESSURE IS REGULATED IN BETWEEN THE TOP AND LOWER ARMS, WHICH ALLOWS A SOFT-CLOSING OR A STRONGER-CLOSING OF THE DOOR.

1. A HINGE OF THE 3D ADJUSTABLE HIDDEN TYPE COMPRISING:
A PRIMARY SYMMETRICBODY FIXED TO A FRAME, WITH A CENTRAL COUPLING OPENING;
A SECOND SYMMETRIC BODY FIXED TO A DOOR, WITH A COUPLING OPENING, UNITED IN BETWEEN THROUGH AN OPENING AND CLOSING MECHANISM, WHEREIN
A TOP ARM, A LOWER ARM, UNITED IN BETWEEN THROUGH A CENTRAL REGULATION SCREW, THE TOP ARM IS ARTICULATED BY A PART TO THE SECOND SYMMETRIC BODY AND DISPACABLE THROUGH A CHANNEL LOCATED IN THE FIRST SYMMETRIC BODY AND THE LOWER ARM IN AN INVERSE WAY, WITH THE PARTICULARITY THAT BOTH ARMS ARE SHAPED BY ARCHED PIECES, BEING BOTH ARMS ARTICULATED IN BETWEEN THEMSELVES IN CORRESPONDENCE WITH A CROSSING-ZONE AMONG THEMSELVES;
A REGULATION OF THE INCLINATION OF THE DOOR'S TOP PART'S SCREW;
A REGULATION OF INCLINATION OF THE DOOR'S LOWER PART'S SCREW;
A DOOR'S HEIGHT TOP PART REGULATION SCREW, A DOOR'S HEIGHT LOWER PART REGULATION SCREW, A LATERAL REGULATION SCREW, TOP PRISONER SCREW, LOWER PRISONER SCREW; AND
A DISPLACEMENT CHANNEL.

2. THE HINGE OF THE 3D ADJUSTABLE HIDDEN TYPE ACCORDING TO CLAIM 1, WHEREIN SAID HINGE SUPPORTS DOORS WITH WEIGHTS FROM 80 KILOGRAMS TO 120 KILOGRAMS.

3. THE HINGE OF THE 3D ADJUSTABLE HIDDEN TYPE ACCORDING TO CLAIM 1, WHEREIN SAID HINGE IS BUILT WITH AN ALLOY OF ZINC WITH ALUMINUM MAGNESIUM AND COPPER, A MATERIAL HIGHLY RESISTANT TO CORROSION, THE SUN, THE RAIN, AND THE SALINITY.

4. THE HINGE OF THE 3D ADJUSTABLE HIDDEN TYPE ACCORDING TO CLAIM 1, WHEREIN THE DOOR CAN BE ADJUSTED UP TO A +2.5 MM LATERALLY.

5. THE HINGE OF THE 3D ADJUSTABLE HIDDEN TYPE ACCORDING TO CLAIM 1, WHEREIN THE DOOR CAN BE ADJUSTED UP TO A HEIGHT OF +2.5 MM.

6. THE HINGE OF THE 3D ADJUSTABLE HIDDEN TYPE ACCORDING TO CLAIM 1, WHEREIN THE DOOR CAN BE ADJUSTED UP TO A +1.0 MM DEPTH.

7. THE HINGE OF THE 3D ADJUSTABLE HIDDEN TYPE ACCORDING TO CLAIM 1, WHEREIN WITH THE CENTRAL REGULATION SCREW ONE CAN REGULATE THE PRESSURE BETWEEN THE LOWER ARM AND THE TOP SUPERIOR ARM, WHICH IT ALLOWS A DOOR'S SOFT-CLOSURE, OR A DOOR'S STRONGER ONE.
